(19) United States
(12) Patent Application Publication
(10) Pub. No.: US 2008/0116807 A1
(43) Pub. Date: May 22, 2008

(54) Magnetron

(76) Inventors: Jung-Il Kim, Seoul (KR); Jong-Hyo Won, Incheon-city (KR); Gun-Sik Park, Seoul (KR)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/720,363

(22) PCT Filed: Dec. 30, 2004
(86) PCT No.: PCT/KR04/03526

§ 371 Date: Aug. 8, 2007

(30) Foreign Application Priority Data
Nov. 30, 2004 (KR) 10-2004-0099279

(51) Int. Cl. H01J 23/18; H01J 25/50

(52) U.S. Cl. 315/5.13

(57) ABSTRACT

A magnetron has a cylindrical cathode portion, an anode portion surrounding the cathode portion concentrically, and a resonator circuit connected to the anode portion. Fine modifying portions are periodically formed on the anode portion in an azimuthal direction to encourage electrons in bunching, thereby reducing a start-oscillation time and noise signals.

### BACKGROUND OF THE INVENTION

(a) Field of the Invention

The present invention relates to a magnetron, and more particularly to a magnetron having fine modifying portions formed periodically on an anode portion to reduce noise signals.

(b) Description of the Related Art

Generally, a magnetron is a kind of a microwave generating apparatus which is applied to home appliances such as a microwave oven. The magnetron has a cathode portion for emitting electrons which are rotated by applying a magnetic field perpendicular to the electric field.

FIG. 9 shows a schematic sectional view of the oscillating circuit portion of a conventional A6 magnetron. The magnetron has a cylindrical cathode portion 1 elongated in a direction perpendicular to a surface for emitting an electron beam, and an anode portion 2 surrounding the cylindrical cathode portion concentrically. The anode portion 2 has several resonator cavities 3 which are arranged in a periodic manner in an azimuthal direction. The electrons emitted from the cathode portion 1 are rotated by a magnet which is not shown in the drawing. The electrons are rotated in a pi (π) mode as an operational mode among several modes which satisfy boundary conditions of the resonator cavities 3. Then, the electrons start to form bunches in an operational mode due to the interaction with the resonator cavities 3, and this results in the generation of electromagnetic waves. The wave generation is begun at some time after initial power is supplied. When this start-oscillation time is long, it allows enough time to form several modes to make unwanted noise signals.

In order to reduce the noise signals, a noise reduction method has been proposed in which a periodic small magnetic field is applied in addition to a main magnetic field [see Applied Physics Letters, Vol. 83, No. 10, p 1938 (2003), and Applied Physics Letters, Vol. 84, No. 6, p 1016 (2004)]. However, an additional magnet is required to apply the periodic small magnetic field in this method, resulting in drawbacks that the dimensions, weight, and manufacturing costs of the magnetron are increased, as well as that fine control of the electron beam difficult to achieve.

### SUMMARY OF THE INVENTION

In view of the prior art described above, it is an object of the present invention to provide a magnetron having fine modifying portions formed periodically on an anode portion to reduce a start-oscillation time and to achieve low noise.

It is another object of the present invention to provide a low noise magnetron without increasing dimensions or weight as well as without using any additional magnet.

It is another object of the present invention to provide a magnetron which is capable of reducing noise signals and a start-oscillation time regardless of a specific structure of an interaction circuit.

To achieve these and other objects, a magnetron according to the present invention has fine modifying portions which are periodically formed on an anode portion. That is, the magnetron according to the present invention has a cylindrical cathode portion, an anode portion surrounding the cathode portion concentrically, and a resonator circuit connected to the anode portion. The fine modifying portions are periodically formed on the anode portion in an azimuthal direction.

When the anode portion has a plurality of anodes, the fine modifying portions may be formed on all of the anodes or only half of the anodes.

The fine modifying portions have projections protruding from a surface of the anode and/or recesses retracted from the surface of the anode. The projections and the recesses may alternate with each other. Alternatively, an anode on which the modifying portions are formed may alternate with an anode on which the modifying portions are not formed.

Each fine modifying portion has a cross-section in a surface vertical to the axis of the cathode portion that may be selected from a group comprising a rectangular, a square, a circle, an ellipse, a triangle, a trapezoid, and other polygons.

The present invention is applied to a magnetron whose resonator circuit is a vane type, a slot type, a hole and slot type, a rising sun type, or a strapped type of circuit.

### BRIEF DESCRIPTION OF THE DRAWINGS

FIG. 1 shows a schematic sectional view of a magnetron according to a first embodiment of the present invention;

FIG. 2 shows a view illustrating a magnetron of FIG. 1;

FIGS. 3a and 3b show views of an electron beam distribution at 2 ns in a magnetron of FIG. 1 and FIG. 9, respectively;

FIGS. 4a and 4b show views of an electron beam distribution at 4 ns in a magnetron of FIG. 1 and FIG. 9, respectively;

FIGS. 5a and 5b show graphs of a voltage signal with respect to time in a magnetron of FIG. 1 and FIG. 9, respectively;

FIGS. 6a and 6b show views of graphs of a frequency component of a measured voltage in a magnetron of FIG. 1 and FIG. 9, respectively;

FIG. 7 shows a schematic sectional view of a magnetron resonator circuit according to a second embodiment of the present invention;

FIGS. 8a to 8c show schematic sectional views of a magnetron resonator circuit according to another embodiment of the present invention; and

FIG. 9 shows a schematic sectional view of a conventional magnetron resonator circuit.

### DETAILED DESCRIPTION OF THE PREFERRED EMBODIMENTS

Preferred embodiments of the present invention will hereinafter be described in detail with reference to the accompanying drawings, where like numerals of reference designate like elements throughout.

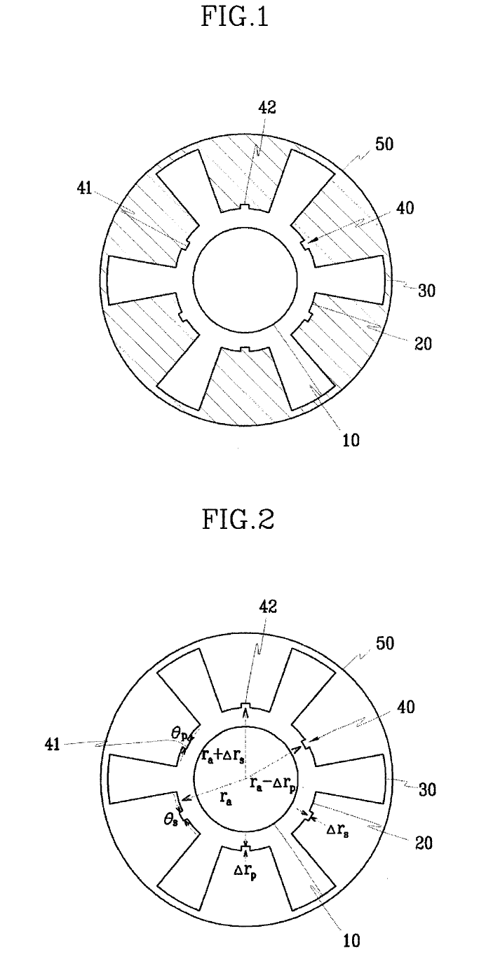

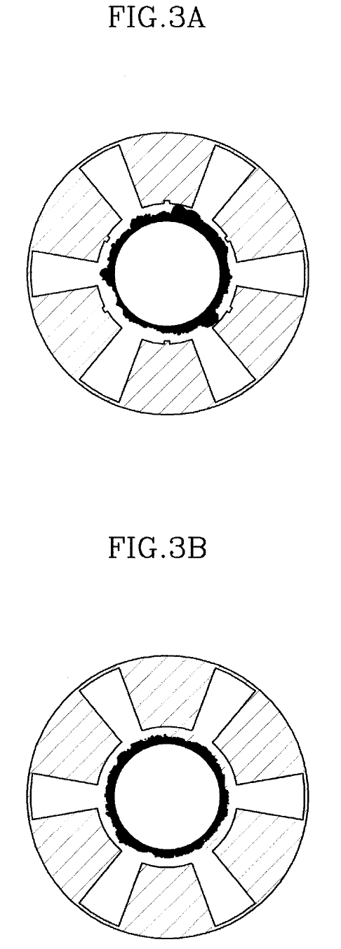

Referring first to FIG. 1, a magnetron according to a first embodiment of the present invention will be described. The magnetron is a kind of an A6 type of magnetron which has a cylindrical cathode portion 10 elongated in a direction perpendicular to surface and an anode portion 20 surrounding the cylindrical cathode portion concentrically. The cathode portion 10 emits electron beams. The anode portion 20 has an azimuthally periodic structure with an even number of anodes to provide an annular interaction space with respect to the cathode portion 10. The anode portion 20 of the first embodiment has six anodes, and each anode has a fine modifying portion 40 thereon. The fine modifying portions 40 are in the shape of projections 41 protruded from the surface of the anode and recesses 42 retracted from the surface of the anode. The projections and recesses are formed to alternate with each other. As shown in FIG. 2, the anode portion 20 has an azimuthal angle θₐ and is placed at a radius rₐ. Each odd-numbered anode has a projection 41 having an azimuthal angle magnitude θₚ and a radius rₐ−Δrₚ which is protruding toward the cathode portion as magnitude Δrₚ, while each even-numbered anode has a recess 42 having an azimuthal angle magnitude θₛ and a radius rₐ+Δrₛ which is retracted as magnitude Δrₛ.

A resonator cavity 30 is connected to the anode portion 20 and formed periodically. A magnet which is not shown in the drawing is arranged vertical to the axis of the cathode portion 1 to rotate electrons emitted from the cathode portion 10.

The apparatus according to the first embodiment of the present invention operates as follows.

The electrons emitted from the cathode portion 10 are rotated by a magnetic field due to the magnet (not shown), and they begin to bunch at an operation mode which has phase difference π (180 degrees) between an adjacent resonator cavity 30. At this time, the fine modifying portion 40 produces the modification of the electric field, which changes velocities of the electrons resulting in electron beam bunching that is periodic in a desired mode at a predetermined area. The effects due to the early electron bunching by the fine modifying portions reduce a start-oscillation time and obtain low noise to generate electromagnetic waves.

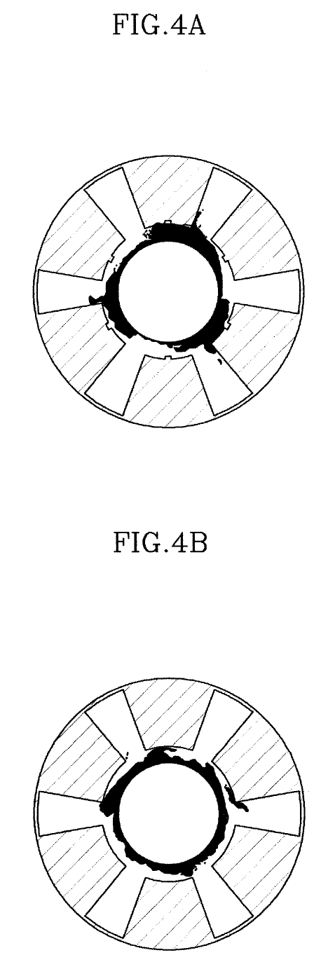

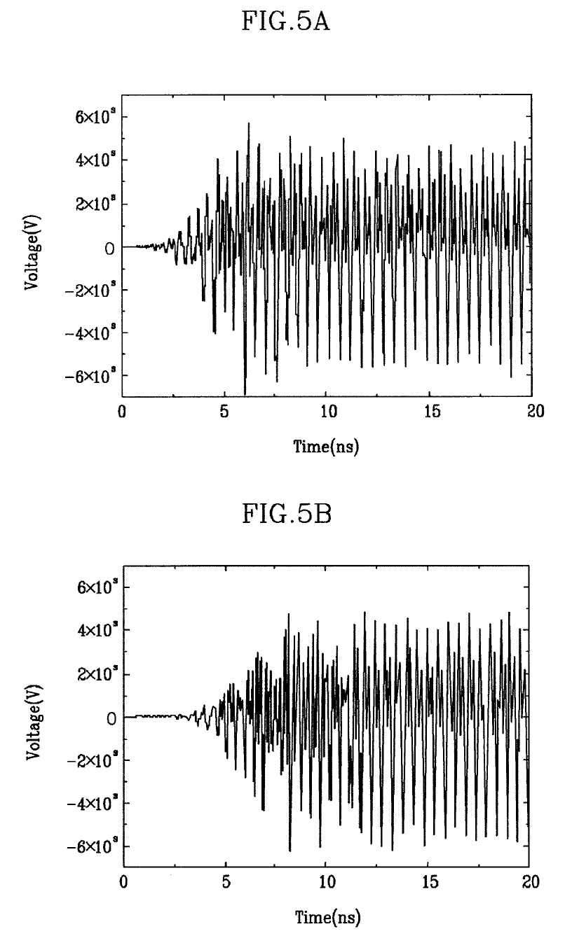

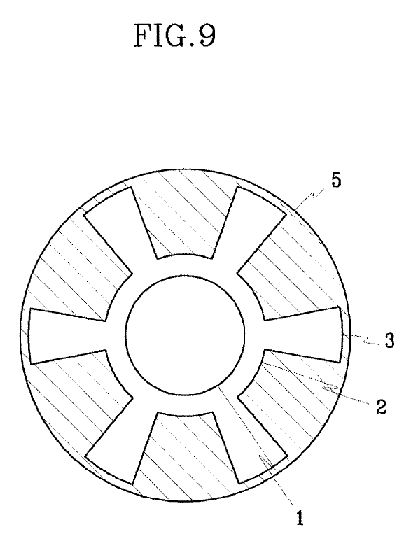

FIGS. 3a and 3b shows simulation results proving that a start-oscillation time is reduced in the magnetron of the first embodiment compared to the conventional magnetron of FIG. 9. For simulation, a voltage of 350 kV is set to be applied between the cathode portion and the anode portion of the magnetron, a magnetic field of 7.2 kG is set to be applied in the direction of the cathode portion, the radius of the cathode portion is set to be 1.58 cm, and the radius of the anode rₐ and the radius of the cavity circuit are set to be 2.11 cm and 4.11 cm, respectively. The azimuthal angle magnitude θₐ, θᵥ of the anode and the cavity circuit are set to be 40 degrees and 20 degrees, respectively, in the magnetron of the first embodiment. The radius Δrₚ, Δrₛ of the modifying portions is set to be 3.5% of the anode radius rₐ, and the azimuthal angle magnitude θₚ, θₛ is set to be 8 degrees. FIG. 3a shows an electron beam distribution at 2 ns in the magnetron of the first embodiment, and FIG. 3b shows an electron beam distribution at 2 ns in a conventional magnetron of FIG. 9. Comparing FIG. 3a to FIG. 3b, the electron distribution of the conventional magnetron is uniform in an azimuthal direction without any bunching effect of the electron beam (as shown in FIG. 3b), while the electrons start to bunch together in three bunches in the magnetron of the first embodiment (as shown in FIG. 3a). FIGS. 4a and 4b illustrate the comparison of electron distribution at 7 ns. FIG. 4b shows that the electrons start to gather together in some areas in the conventional magnetron, while FIG. 4a shows the electron bunch is completely formed in the magnetron of the first embodiment.

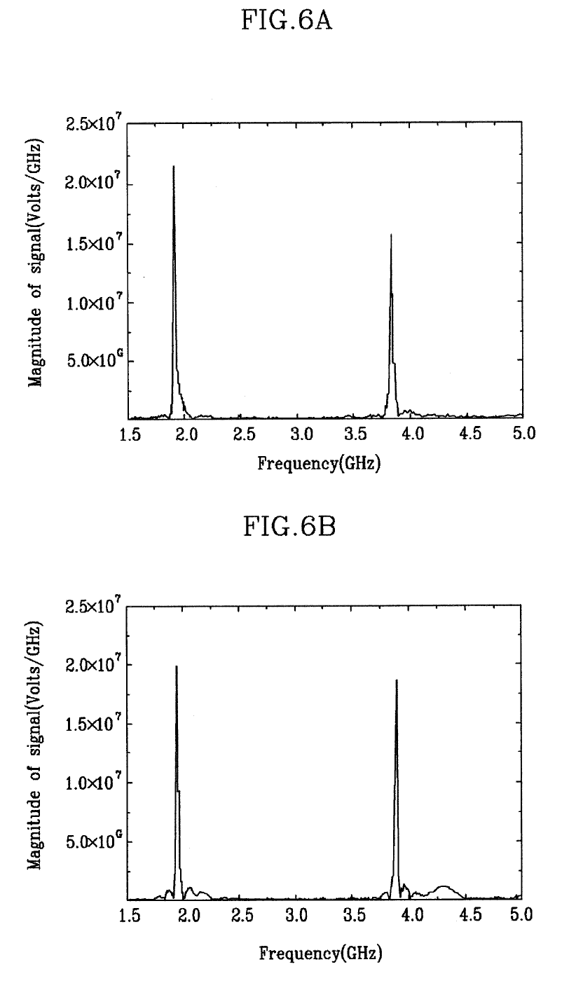

Further, voltage signals measured in the resonator cavities 30 and 3 are shown in FIGS. 5a and 5b, respectively, in order to compare start-oscillation times. FIG. 5b shows that the conventional magnetron starts to oscillate at 3.24 ns and oscillates stably at 11.88 ns. In contrast, FIG. 5a shows that the magnetron of the first embodiment starts to oscillate at 1.6 ns, which is twice as rapid compared to the conventional magnetron.

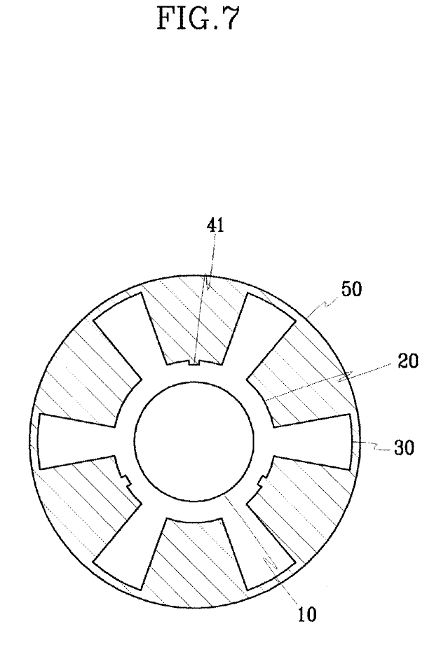

FIGS. 6a and 6b show frequency components showing whether the reduced start-oscillation time actually affects the reduction of the noise signal. The two strong peaks of frequencies at 1.95 GHz and 3.9 GHz are a π mode and a 2π mode, respectively, in the diagrams. FIG. 6b shows other frequency components that have a difference of 80 MHz and 120 MHz from the π mode, in addition to the π mode in the conventional magnetron. In contrast, FIG. 6a shows that little frequency component appears other than at the π mode.

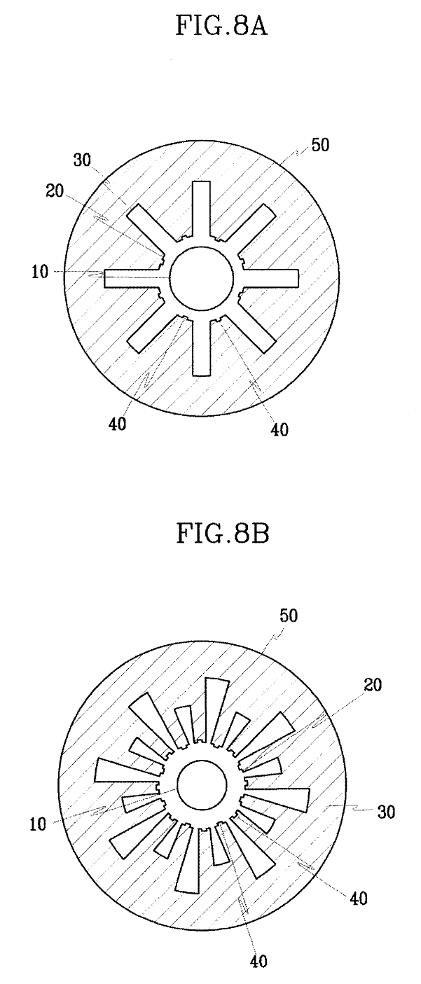

Referring next to FIG. 7, a magnetron according to a second embodiment of the present invention will be described.

The second embodiment is similar to the first embodiment, except for the shape of a fine modifying portion. The magnetron of the second embodiment has projections 41 on half of the anodes. That is, the anodes on which the projections 41 are formed alternate with the anodes without the projections. The second embodiment also has a reduced start-oscillation time and low noise signals due to the electron beam bunching effect by the projections 41.

The projections 41 may be substituted with recesses which results in similar bunching effects to that of the second embodiment, although this is not shown.

Although the first and second embodiments show shapes of the fine modifying portions, the shapes of the fine modifying portions are not limited thereto. They may be selected from a group including a rectangle, a square, a circle, an ellipse, a triangle, a trapezoid, and other polygons. Further, a part of a segment that forms a cross-section of the fine modifying portion is a straight line, a circular arc, or a curve.

It is possible to modify the shape, structure, and arrangement of the fine modifying portions in various manners according to the specific design of a magnetron, to finely adjust the electron beam bunching.

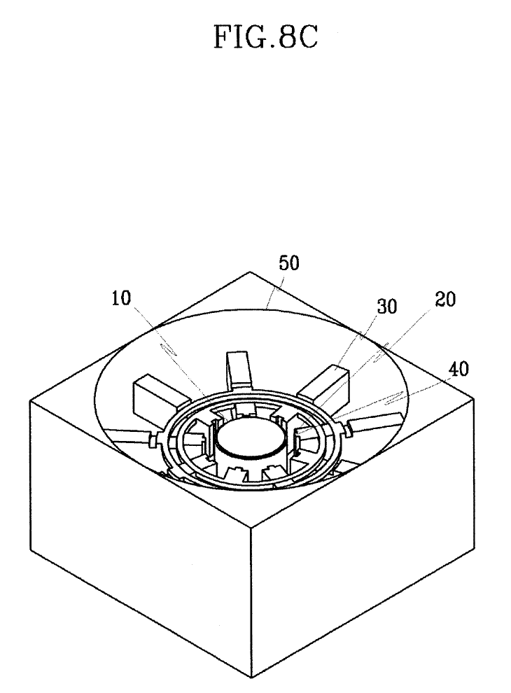

FIGS. 8a to 8c show another embodiment of a magnetron according to the present invention. The magnetrons of FIGS. 1 and 2 have fine modifying portions formed on an A6 magnetron, which a vane type of magnetron. FIGS. 8a, 8b, and 8c show a slot type of magnetron, a rising sun type of magnetron, and a strapped type of magnetron in which fine modifying portions are formed, respectively. It is noted that the present invention may be applied to other kinds of magnetrons as well as the above exemplary magnetrons and is not limited to a specific structure of the resonator cavity.

As described above, a magnetron according to the present invention has fine modifying portions on an anode portion to reduce noise signals without an additional magnet. Therefore, the noise signals are effectively reduced without increasing dimensions or weight of the magnetron.

Further, a magnetron according to the present invention is capable of reducing a start-oscillation time regardless of a specific structure of magnetron or an interaction circuit. The present invention allows the structure and the arrangement of the fine modifying portions to be modified in order to finely control the electron beam bunching.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A magnetron comprising:
a cylindrical cathode portion;
an anode portion spaced from the cathode portion and surrounding the cathode portion concentrically; and
a resonator circuit connected to the anode portion,
wherein fine modifying portions are periodically formed on the anode portion in an azimuthal direction.

2. The magnetron as recited in claim 1,
wherein the anode portion comprises a plurality of anodes, and
wherein the fine modifying portions are formed on all the plurality of the anodes,
wherein the fine modifying portions comprise:
projections protruding from a surface of each anode; and
recesses retracted from the surface of each anode,
wherein the projections and the recesses alternate with each other.

3. The magnetron as recited in claim 1,
wherein the anode portion comprises a plurality of anodes;
wherein the fine modifying portions are formed on half of the anodes; and
wherein the anodes on which the modifying portions are formed alternate with the anodes on which no modifying portions are formed.

4. The magnetron as recited in claim 3, wherein each fine modifying portion is a projection protruded from the surface of the anode portion.

5. The magnetron as recited in claim 3, wherein each fine modifying portion is a recess retracted from the surface of the anode portion.

6. The magnetron as recited in claim 1, wherein each fine modifying portion has a cross-section in a surface vertical to the axis of the cathode portion that is selected from a group comprising a rectangular, a square, a circle, an ellipse, a triangle, a trapezoid, and other polygons.

7. The magnetron as recited in claim 6, wherein a part of a segment that forms a cross-section of a fine modifying portion is a straight line, a circular arc, or a curve.

8. The magnetron as recited in claim 1, wherein the resonator circuit is selected from a vane type, a slot type, a hole and slot type, a rising sun type, and a strapped type of circuit.
